(19) United States
(12) Patent Application Publication
(10) Pub. No.: US 2005/0108133 A1
(43) Pub. Date: May 19, 2005

(54) Service shopping and provisioning system and method

(75) Inventors: Mukund Balasubramanian, Cupertino, CA (US); Patrick Vallaeys, Los Altos, CA (US); Jeff Tonkel, Saratoga, CA (US); Rajesh Koilpillai, Tamil Nadu (IN)

Correspondence Address: CARR & FERRELL LLP, 2200 GENG ROAD, PALO ALTO, CA, 94303, US

(73) Assignee: Infravio, Inc.

(21) Appl. No.: 10/990,097

(22) Filed: Nov. 15, 2004

Related U.S. Application Data
(63) Continuation-in-part of application No. 10/863,773, filed on Jun. 7, 2004.
(60) Provisional application No. 60/520,230, filed on Nov. 14, 2003.

(51) Int. Cl. G06F 17/60

(52) U.S. Cl. 705/35

(57) ABSTRACT

The invention includes systems and methods of facilitating interaction between service consumers and services providers based on service contracts. These service contracts are established by considering preferences, capabilities or limitations of each service consumer and at least one characteristic of each service provider. Once the preferences, capabilities or limitations of a service consumer are determined these may be used to automatically establishe individualized service contracts with a variety of service providers. The services contracts may include contract terms relating to data format, communication protocol, security, data logging, load balancing, service level agreements, service quality, performance requirements, or the like. The systems and methods of the invention optionally include an online service marketplace configured for searching and obtaining available services, for generating service contract data or for generating new services responsive to service consumer data.

### CROSS-REFERENCE TO RELATED APPLICATIONS

This application is a continuation-in-part of U.S. patent application Ser. No. 10/863,773, entitled “Contract Based Enterprise Application Services,” filed Jun. 7, 2004; which claims benefit of commonly owned U.S. Provisional Patent Application No. 60/520,230, entitled “Contract Based Enterprise Application Services” and filed Nov. 14, 2003; this application claims benefit of commonly owned U.S. Provisional Patent Application No. 60/614,897, entitled “Service Shopping System and Method” and filed Sep. 29, 2004. The disclosures of these patent applications are herein incorporated by reference.

### BACKGROUND

1. Field of the Invention

The invention is in the field of enterprise applications on computer networks and more specifically in the field of enterprise application interfaces.

2. Related Art

Computer networks first became successful because of the advantages and convenience of transferring data between computers. Building on this success, systems have been developed wherein the transferred data is associated with remote execution of applications over a computer network. For example, in some cases, network applications are hosted by an application service provider and accessed via a network client. Network applications may be shared by several users, allow the use of thin clients, and may be easier to maintain than numerous copies of an executable distributed among many computers. This architecture may be applied to both extranets and intranets.

The architectures used by application service providers are typically similar to that of a website accessed by clients over the internet. Each interaction between a service provider and a service consumer is based on a communication protocol demanded by the network application and each communication session is based on a one-to-many relationship between the one service provider and possibly many service consumers. For example, in a typical system, a network application is implemented with a specific policy regarding how it communicates and responds to data from any service consumer. This policy prescribes factors such as communications, security, available services, and data exchange standards. All service consumers are subject to the same policy and are thus treated equally. In some cases, the policy may allow an individual service consumer to use a user identifier to access data associated with a specific user account. This data may be private to the service consumer, may provide password control, and may be used to customize a visual interface, but is not used to change the underlying policy that governs interaction between the service provider and any service consumer.

FIG. 1 illustrates a prior art architecture including a variety of service consumers and service providers communicating through a computer network. The service consumers include a Portal 110, a B2B (business to business) Exchange 120, and a Customer Service Interface 130. These service consumers use a Network 140, such as the internet, to request and receive services from service providers including, for example, an ERP (enterprise resource planning) Service 150, a CRM (customer relationship management) Service 160, and a Financial Service 170. Each service provider interacts with potentially many service consumers on a one-to-many basis under a policy associated with the service provider.

When only one type of service consumer uses a particular service provider the fixed policy of the particular service provider may be advantageous. Any service consumer knowing the policy can access the service and all service consumers are treated the same. A service consumer may even be anonymous. However, when a variety of different service consumers use the same service provider, the single policy architecture is a significant disadvantage. Portal 110, B2B Exchange 120 and Customer Service Interface 130 may all want to use ERP Service 150, but the demands of each of these service consumers are likely to be different. For example, considering just authentication of the service consumer, consumers Portal 110 may need to use a user identifier and password entered through the portal, B2B Exchange 120 may need to use an authentication certificate, and Customer Service Interface 130 may need to use some other authentication or security scheme. A fixed authentication policy, as used in the prior art, does not allow for this variation. This problem arises because all service consumers are subject to the same authentication routines established by ERP Service 150.

FIG. 2 illustrates an alternative architecture of the prior art. In this architecture, a Service Interface 210 is used as an interface between the service consumers and the service providers. Service Interface 210 may be used to establish one policy shared by the service providers and may be able to perform simple operations such as data format conversion. One common protocol is an access protocol named SOAP (simple object access protocol). SOAP is a lightweight protocol for exchange of information between service consumers and service providers in a network environment. SOAP is an XML based protocol including policies defining how data can be packaged and communicated. The definition specifies three parts: an envelope that defines a framework for describing what is in a message and how to process it; a set of encoding rules for expressing instances of application-defined data types; and a convention for representing remote procedure calls and responses. Data received using the SOAP protocol may be converted to an alternative format by Service Interface 210 before being passed to one of the service providers shown in FIG. 2.

While Service Interface 210 and protocols such as SOAP can handle simple variations in data format they are inadequate for handling many of the other problems that occur in multi-service consumer/multi-service provider environments. For example, the problem of conflicting authentication needs discussed above is not solved by addition of Service Interface 210. Rather, Service Interface 210 merely moves the problem to a different location in the architecture. Service Interface 210 still treats each service consumer in the same way, regardless of the each service consumer's particular needs or preferences.

The above problems are magnified in systems involving multiple service consumers and multiple service providers. There is a need for improved methods of interaction between service consumers and service providers in network based applications.

### SUMMARY OF THE INVENTION

The invention includes systems and methods of facilitating interaction between service consumers and service providers based on service contracts. These service contracts are established by considering preferences, capabilities or limitations of each service consumer and at least one characteristic of a service or service provider. Through these service contracts, each service provider/service consumer interaction may be subject to an individualized set of interaction policies (e.g., set of service contract terms).

Preferences of a service consumer include things that are preferred but not required by a service consumer. For example, in one embodiment, preferences include preferred methods of exchanging data. A service consumer may prefer to exchange data in a specific format or using a specific protocol. Capabilities include what a service consumer is capable of doing. For example, a specific service consumer may be capable of using three particular alternative encryption routines and one particular data compression routine. Limitations include excluded capabilities. For example, a service consumer may not be able to utilize RPC (remote procedure call) service or may only be able to communicate using SSL (secure socket layer) protocols.

Service contracts are typically based on one or more characteristics of the service provider and the preferences, capabilities or limitations of a service consumer. For instance, in some embodiments, contracts are determined using a service provider characteristic and preferences of the service consumer. In some embodiments, contracts are determined using a service provider characteristic, and capabilities and limitations of the service consumer. In some embodiments, contracts are determined using a service provider characteristic, and preferences, capabilities and limitations of the service consumer.

Once specified, the preferences, capabilities or limitations of a service consumer may be used to establish more than one service contract with more than one service provider. Thus, the specified information may be reused to establish custom interaction characteristics for a variety of service providers. Each service consumer/service provider interaction may be performed under different service contract terms (e.g., a different service policy) that are responsive to both the service provider and the service consumer.

Various embodiments of the invention include a network application system comprising a service broker configured to act as an intermediary between a service provider and a service consumer, the service consumer having an identity and being characterized by a) a consumer preference, and/or b) a consumer limitation and a consumer capability, the service broker including an input/output configured to exchange service consumer data with the service consumer and to exchange provider data with the service provider, a memory configured to store service contract data selected using the service consumer identity and generated responsive to a characteristic of the service provider and the consumer preference, consumer limitation or consumer capability, of the service consumer, and a mechanism configured to use the contract data to process the service consumer data and the provider data according to the service contract data.

Various embodiments of the invention include a method of operating a network application system, the method comprising providing a service consumer identity to a service broker, the service consumer identity configured for the service broker to select first service contract data characterizing a first service contract, the selected first service contract data being responsive to a preference, a capability or a limitation of the service consumer, and a characteristic of a service provider, and communicating between the service consumer and the service provider response to a term of the first service contract.

Various embodiments of the invention include a method of operating a network application system, the method comprising receiving a service consumer identity from a service consumer, the service consumer identity configured for selecting service contract data, selecting first service contract data responsive to the service consumer identity, the selected first service contract data being responsive to a preference, a capability or a limitation of the service consumer and a characteristic of a service provider, communicating with the service consumer under a service contract term characterized by the service contract data, and communicating with the service provider under a service contract term characterized by the service contract data.

Various embodiments of the invention include a method of operating a network application system, the method comprising receiving a service consumer identity from a service consumer, selecting service contract data from a plurality of service contract data using the service consumer identity, the selected service contract data being responsive to a preference, a capability and a limitation of the service consumer, and a characteristic of a service provider, storing the service contract data in local memory in a pre-compiled format, receiving first communications from the service consumer, processing the first communications using the stored service contract data, sending a result of processing the first communications to the service provider, receiving second communications from the service provider responsive to the sent result of processing the first communication, processing the second communications using the stored service contract data, and sending a result of processing the second communications to the service consumer.

Various embodiments of the invention include a method of operating a network application system, the method comprising receiving a first service consumer identity from a first service consumer, the first service consumer identity configured for selecting first service contract data, the selected first service contract data being previously determined using a configuration engine responsive to a preference, a capability or a limitation of the first service consumer, and a characteristic of a first service provider, the preference including a preferred data format, the capability including an encryption capability, and the limitation concerning a communication protocol, pre-compiling the first service contract data for run-time use, communicating between the first service consumer and the first service provider based on the pre-compiled first service contract data, receiving a second service consumer identity from a second service consumer, the second service consumer identity configured for selecting second service contract data, the selected second service contract data being different than the selected first service contract data and being configured to specify terms by which the first service provider provides services to the second service consumer, pre-compiling the second service contract data for run-time use, and communicating between the second service consumer and the first service provider based on the second service contract data.

Various embodiments of the invention include a method of operating a network application system, the method comprising receiving a first service consumer identity from a first service consumer, the first service consumer identity configured for selecting service contract data previously determined using a configuration engine responsive to a preference, a-capability or a limitation of the first service consumer, and a characteristic of a service provider, receiving a first service request from the first service consumer, selecting a first service provider responsive to the first service request, the first service provider having a characteristic, selecting first service contract data responsive to the service consumer identity and the characteristic of the first service provider, communicating between the first service consumer and the first service provider based on the selected first service contract data, receiving again the first service consumer identity from the first service consumer, receiving a second service request from the first service consumer, selecting a second service provider responsive to the second service request, the second service provider having a characteristic, selecting second service contract data responsive to the service consumer identity and the characteristic of the second service provider, the second service contract data being different than the first service contract data, both the first service contract data and the second service contract data being responsive to a preference, a capability or a limitation of the service consumer, and communicating between the first service consumer and the second service provider based on the selected second service contract data.

Various embodiments of the invention include a system comprising means for receiving a service consumer identity from a service consumer, the service consumer identity configured for selecting service contract data, means for selecting first service contract data responsive to the service consumer identity, the selected first service contract data being responsive to a preference, a capability or a limitation of the service consumer and a characteristic of a service provider, means for communicating with the service consumer under a service contract term characterized by the service contract data, and means for communicating with the service provider under a service contract term characterized by the service contract data.

Various embodiments of the invention include a computer readable medium having thereupon computer instructions comprising a code segment configured for receiving a service consumer identity from a service consumer, the service consumer identity configured for selecting service contract data, a code segment configure for selecting first service contract data responsive to the service consumer identity, the selected first service contract data being responsive to a preference, a capability or a limitation of the service consumer and a characteristic of a service provider, a code segment configure for communicating with the service consumer under a service contract term characterized by the service contract data, and a code segment configure for communicating with the service provider under a service contract term characterized by the service contract data.

Various embodiments of the invention include a service access system comprising an online service marketplace configured for selecting a first service from among a plurality of services, the selection of the first service being responsive to selection criteria received from a service consumer, the selection criteria including a consumer preference, a consumer limitation or a consumer capability, and a mechanism configured to determine first service contract data responsive to the selection criteria and the service provider data, the first service contract data being configured for characterizing a first service contract for the provision of the first service by a service provider to a service consumer using a computer network.

Various embodiments of the invention include a service search system comprising an online service marketplace accessible to a service consumer, the service consumer having an identity and being characterized by a) a consumer preference, or b) a consumer limitation and a consumer capability, the online service marketplace including an input/output configured to exchange service consumer data with the service consumer, a mechanism configured to use the service consumer data to identify first service provider data from among a plurality of service provider data, the first service provider data being associated with a service provided by a service provider and being configured to for generating service contract data responsive to the consumer preference, consumer limitation or consumer capability, of the service consumer, and a memory configured to store the plurality of service provider data.

Various embodiments of the invention include a service development system comprising a service marketplace configured for receiving selection criteria from a plurality of service consumers, each of the selection criteria including a consumer preference, a consumer limitation or a consumer capability, the selection criteria being configured for selecting a service from among a plurality of services, memory configured to store the received selection criteria, a data analyzer configured to process the stored selection criteria and to statistically analyze the consumer preferences, consumer limitations or consumer capabilities included in the stored selection criteria, and a service provider configured to provide a first service developed responsive to the statistical analysis.

Various embodiments of the invention include a contract negotiation system comprising a service marketplace configured for receiving selection criteria from a service consumer, the selection criteria including a consumer preference, a consumer limitation or a consumer capability, the selection criteria being configured for showing an initial interest in a service from among a plurality of services, memory configured to store the received selection criteria, a configuration engine configured for determining a first contract term of a contract using the selection criteria and a characteristic of a service provider service configured to provide the service to the service consumer, and an input/output interface configured for negotiating a second term of the contract using a preference, limitation or capability of the service consumer or the service provider.

Various embodiments of the invention include a method of providing a service, the method comprising, receiving at a service broker a first characteristic of a first service, receiving at the service broker a second characteristic of at least a second service receiving at the service broker selection criteria from a service consumer, the selection criteria including a) a consumer preference, and/or b) a consumer limitation and a consumer capability, the selection criteria configured for determining contract data, the determination being responsive to the first characteristic or the second characteristic, comparing the selection criteria with the first characteristic and with at least the second characteristic, the results of the comparison including identification of one or more service that meets the selection criteria, and advising the service consumer of results of the comparison.

Various embodiments of the invention include a method of developing a service, the method comprising receiving a plurality of selection criteria from a plurality of service consumers, each of the selection criteria including a) a consumer preference, and/or b) a consumer limitation and a consumer capability, storing the received selection criteria, statistically analyzing the consumer preferences, consumer limitations or consumer capabilities included in the stored selection material, and determining a characteristic of the service responsive to the statistical analysis, the characteristic, in conjunction with the selection criteria, being configured for determining contract data.

Various embodiments of the invention include a computer readable medium including computing instructions, the computing instructions comprising a code segment configured for receiving a plurality of selection criteria from a plurality of service consumers, each of the selection criteria including a) a consumer preference, and/or b) a consumer limitation and a consumer capability, a code segment configured for storing the received selection criteria, a code segment configured for statistically analyzing the consumer preferences, consumer limitations or consumer capabilities included in the stored selection material, and a code segment configured for determining a characteristic of the service responsive to the statistical analysis, the characteristic, in conjunction with the selection criteria, being configured for determining contract data.

Various embodiments of the invention include a computer readable medium including computing instructions, the computing instructions comprising, a code segment configured for receiving at a service broker a first characteristic of a first service, a code segment configured for receiving at the service broker a second characteristic of at least a second service, a code segment configured for receiving at the service broker selection criteria from a service consumer, the selection criteria including a) a consumer preference, and/or b) a consumer limitation and a consumer capability, the selection criteria configured for determining contract data, the determination being responsive to the first characteristic or the second characteristic, a code segment configured for comparing the selection criteria with the first characteristic and with at least the second characteristic, the results of the comparison including identification of one or more service that meets the selection criteria, and a code segment configured for advising the service consumer of results of the comparison.

### BRIEF DESCRIPTION OF THE VARIOUS VIEWS OF THE DRAWINGS

FIG. 1 illustrates a prior art architecture including a variety of service consumers and service providers communicating through a computer network;

FIG. 2 illustrates an alternative architecture of the prior art;

FIG. 3 is a block diagram illustrating a network application system configured to provide network application services to one or more service consumers, according to various embodiments of the invention;

FIG. 4 is a flow chart illustrating a method of operating a network application system, according to various embodiments of the invention;

FIG. 5 is a flow chart illustrating further methods of operating a network application system, according to various embodiments of the invention;

FIG. 6 illustrates various embodiments of the invention in which a service provider provides application services to more than one service consumer;

FIG. 7 illustrates various embodiments of the invention in which a service consumer obtains application services from two different service providers under different service contract terms;

FIG. 8A illustrates a method of identifying a service, according to various embodiments of the invention;

FIG. 8B illustrates a method of providing an identified service, according to various embodiments of the invention; and

FIG. 9 illustrates a method of using historical data for developing new services or modifying existing services, according to various embodiments.

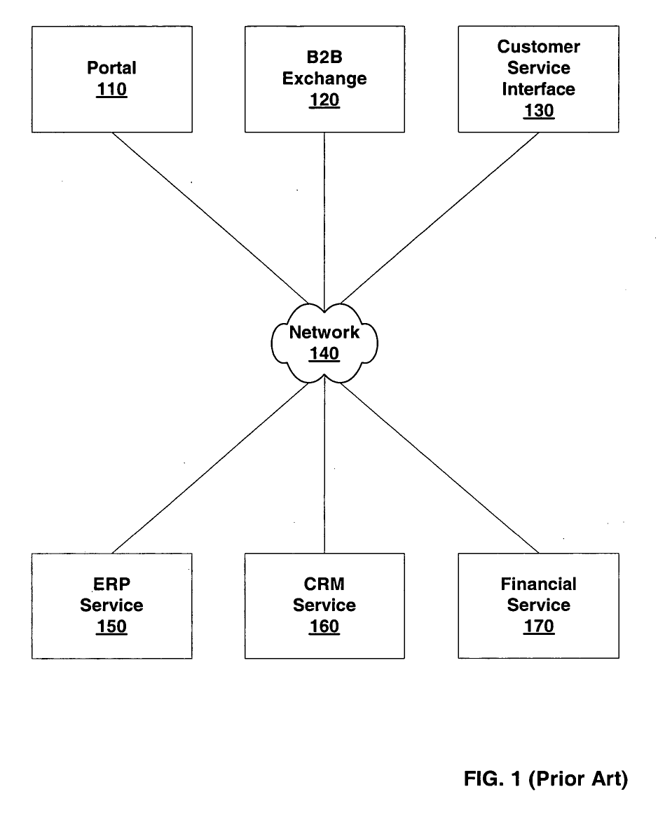

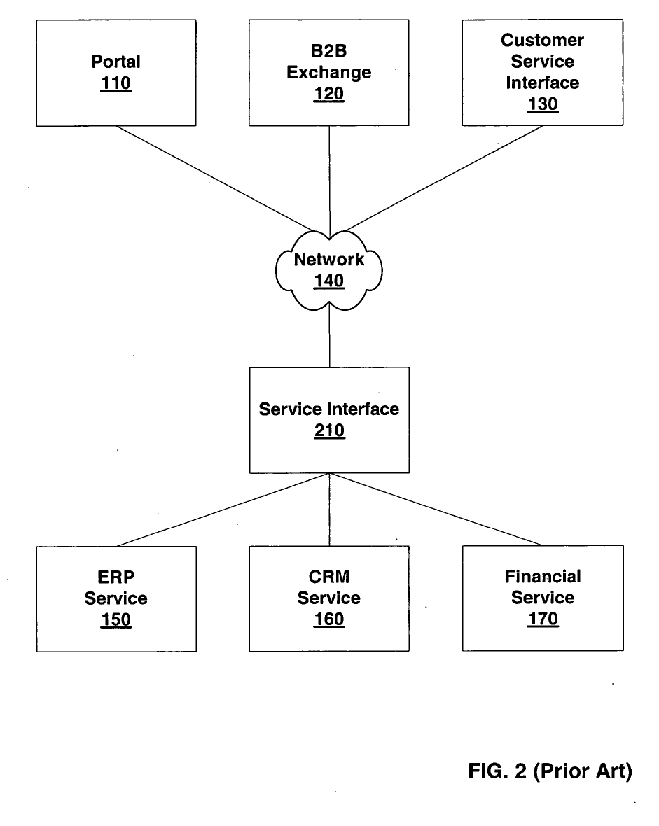

### DETAILED DESCRIPTION

The invention includes systems and methods by which a service consumer and a service provider interact based on a service contract. The service contract is determined by considering one or more preference, capability or limitation of the service consumer and at least one characteristic of the service provider. This characteristic of the service provider may be characteristic of a service provided by the service provider. The service contract may be determined beforehand or in real-time at the start of an interaction.

In some embodiments, a term of a service contract is determined by comparing one or more preferences of the service consumer with a capability or requirement of the service provider. For example, the service consumer may prefer using an HTTPS protocol (hypertext transfer protocol, secure) rather than an HTTP protocol (hypertext transfer protocol) and the service provider may be capable of using either protocol. A resulting term within a service contract may be that their interaction will use HTTPS. In some embodiments, a term of a service contract is determined using a capability and a limitation of the service consumer. For example, if the service consumer is capable of communicating using SMTP (simple mail transfer protocol) and FTP (file transfer protocol) and is not capable of using JMS (java message service), then a resulting service contract term may specify use of SMTP or FTP but not JMS. In some embodiments, a term of a service contract is based on all three factors (preference, capability and limitation) relating to a service consumer. Different terms within the same contract may be based on different factors. In some instances, capabilities and limitations are considered after consideration of a preference has failed to result in an agreed upon contract term. In this case, communication between the service consumer and the service broker may be made using JMS, while communication between the service broker and the service provide may be performed responsive to communication protocol capabilities of the service provider.

A service contract is also determined with consideration of at least one characteristic of the service provider. This characteristic may be a preference, capability, limitation, requirement, or the like. In some embodiments, the characteristics of the service provider are available as a contracting option. However, in contrast with the policies of the prior art, this contracting option is configured for determining terms of a service contract, not for dictating conditions of any interaction. As such, the contracting option of the invention is more flexible than the policies of the prior art, and typically the contracting option alone is insufficient for determining all terms of a service contract. For example, characteristics of a service provider may include a limitation, a preference, and/or a willingness to negotiate a contract term using the preference and limitation as bounds. As described further herein, determination of a complete set of terms of a service contract requires information regarding one or more preference, capability or limitation of the service consumer.

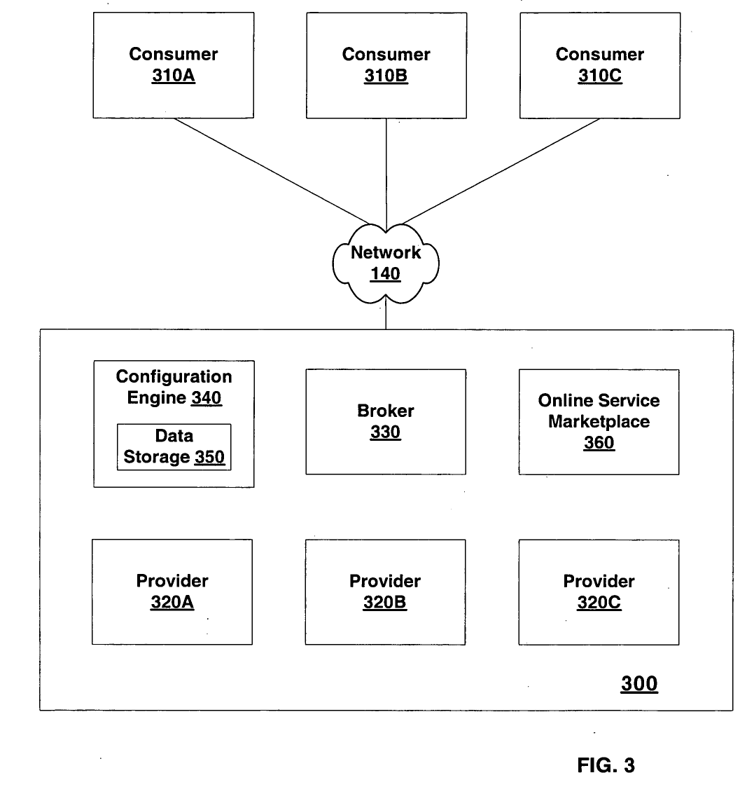

FIG. 3 is a block diagram illustrating a Network Application System 300 configured to provide one or more network application services to one or more service consumers, such as one of Consumers 310A-310C. In some embodiments, these service consumers include a portal, a B2B exchange, a customer service interface, or the like. Network Application System 300 includes one or more service providers, such as one of Service Providers 320A-320C. Service Providers 320A-320C are configured to communicate with Consumers 310A-310C via Network 140 and a Broker 330. In various embodiments, all or part of Broker 330 is associated with an independent third party and/or with one of Consumers 310A-310C, rather than with Network Application System 300 as shown in FIG. 3.

Consumers 310A-310C each have an identity and are characterized by service consumer data including at least a consumer preference, and/or a consumer limitation and a consumer capability. (e.g., In some embodiments, Consumer 310A is characterized by a consumer preference, Consumer 310B is characterized by a consumer limitation and a consumer capability, and Consumer 310C is characterized by a consumer preference, a consumer limitation and a consumer capability.) Each identity is configured to associate service consumer data with one member of Consumers 310A-310C. The service consumer data may be stored in Network Application System 300 or with the member of Consumers 310A-310C to which it applies.

Broker 330 is configured to act as an intermediary between Providers 320A-320C and Consumers 310A-310C. This intermediary action includes identification of the service consumer, determination of a service contract (if not already determined), implementation of the service contract during interaction between service providers and service consumers, and/or management of Providers 320A-320C. In various embodiments, Broker 330 is controlled by a party controlling a member of Consumers 310A-310C, controlled by a party controlling a member of Providers 320A-320C, or controlled by an independent third party. In some embodiments Broker 330 includes an application programming interface (API) configured as a plug-in interface for accessing Broker 330. The application programming interface is optionally static and programmed in advance to be compatible with possible contract terms.

Typically, Broker 330 includes an input/output configured to exchange data with Consumers 310A-310C and to exchange data with Providers 320A-320C. For example, in some embodiments Broker 330 includes a network adaptor configured to communicate with Provider 320A, and a web server accessible through Network 140. Broker 330 may also include a memory configured to store service contract data representative of a service contract currently in operation between a service consumer and a service provider. Typically, this service contract data is selected by Broker 330 using the identity of the service consumer. This selection process is described further herein.

In a typical embodiment, Broker 330 further includes one or more mechanisms to manage communication with other elements of Network Application System 300, to facilitate identification of the service consumer, to process consumer data (data passed between the service consumer and Broker 330), and to process provider data (data passed between the service provider and Broker 330). These mechanisms may include logic circuits, computer instructions, or the like. The consumer data and provider data are processed according to a service contract associated with the service consumer identity.

Network Application System 300 may also include an optional Configuration Engine 340. Configuration Engine 340 is configured to specify preferences, capabilities or limitations of one or more service consumers and, optionally, to specify a characteristic of a service provider. Service consumer data relating to these specifications is stored in a Data Storage 350. In some embodiments, service consumer data is entered manually through a user interface. In some embodiments, service consumer data is received from a service consumer, such as Consumer 310A. Data Storage 350 is optionally accessible from more than one service broker. In some embodiments, Data Storage 350 is further configured to store the specified characteristic of a service provider and/or is accessible through one or more of Providers 320A-320C. Optionally, Data Storage 350 may be further configured to serve other functions such as to serve as a cache of contract data to be looked up by a service broker at runtime, to serve as a temporary storage for data being communicated with Broker 330, to store computer instructions, to store data in an intermediate format during processing, to store historical data, or the like. For example, in some embodiments Data Storage 350 is configured to store, as historical data, either service consumer data previously received from one or more service consumers or data concerning which service provider characteristics historically resulted in successful service contracts. In alternative embodiments, all or part of Configuration Engine 340 is associated with an independent third party or one of Consumers 310A-310C, rather than Network Application System 300 as shown in FIG. 3.

Configuration Engine 340 or Broker 330 are configured to use the service consumer data stored in Data Storage 350 to determine a service contract. For example, when service consumer data relating to preferences, and/or capabilities and limitations, of Consumer 310A are stored in Data Storage 350, Configuration Engine 340 may use this data to determine a contract between Consumer 310A and a service provider. The process of determining a contract is described further herein. In some embodiments, Configuration Engine 340 includes a user interface configured to show to a user details of a service contract. These details include specific service contract terms that are determined using preferences, and/or capabilities and limitations, of a service consumer.

A specific set of preferences, and/or capabilities and limitations associated with a specific service consumer is sometimes a subset of the data necessary to determine a complete contract. Thus, a specific set of preferences, capabilities or limitations may result in different sets of contract terms when used to establish contracts with different service providers. For example, service consumer data for Consumer 310B may include capabilities of communicating through two different protocols. A service contract between Consumer 310B and Provider 320A may include use of a first of these two different protocols, and a service contract between Consumer 310B and Provider 320B may include use of a second of these two different protocols. The user interface of Configuration Engine 340 may be used by a user to view these different contract terms, before, during, or after their use by Broker 330. Once specified, the service consumer data relating to a service consumer may be used to determine contracts (e.g., “service level agreements”) with a variety of different service providers. In some cases, these service providers are not identified until after the service consumer data is specified.

In some embodiments, Configuration Engine 340 is also configured to modify existing service consumer data. For example, Configuration Engine 340 may include an interface that enables a user to change service consumer data stored in Data Storage 350. Once service consumer data is modified, a service contract based on the original service consumer data may be automatically re-determined based on the new service consumer data. Thus, a change to the service consumer data stored in Data Storage 350 may result in changes to service contract terms in more than one service contract.

In some embodiments Network Application System 300 includes an Online Service Marketplace 360 configured for a service consumer to search for services or to negotiate service contracts. For example, Online Service Marketplace 360 may include a service shopping interface configured for a service consumer to identify and purchase services, offer and accept specific service contract terms, or browse available services. Further details of Online Service Marketplace 360 are discussed elsewhere herein.

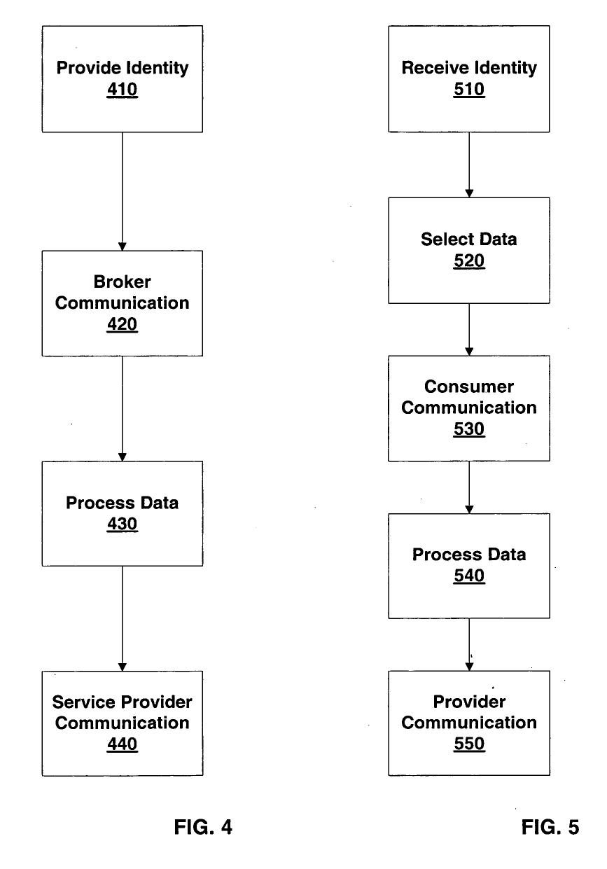

FIG. 4 is a flow chart illustrating various methods of operating Network Application System 300. In these methods, a service consumer provides identifying information to a service broker and the service broker uses the provided information to identify service contract data. The service contract data characterizes one or more service contract terms by which the interaction between the service consumer and service provider occurs. In some embodiments, this communication is through the service broker. Therefore, in these embodiments, the terms of the service contract may determine communication between the service broker and the service consumer, as well as between the service broker and the service provider. In some embodiments, further communication between the service consumer and the service provider does not need to occur through the service broker. In these embodiments, the terms of the service contract determine communication between the service provider and the service consumer.

In a Provide Identity Step 410, an identity of a service consumer, such as Consumer 310A, is provided to a service broker, such as Broker 330. This identity may be, for example, a user name, an account name, a hardware identification, a security certificate, cookie, URL fragment, or the like. Typically, the identity is provided by the service consumer. The identity is used by Broker 330 to select service contract data which is associated with the service consumer and characterizes a service contract. For example, in one embodiment, this selection includes Broker 330 sending the identity to Configuration Engine 340 along with a request that the identity be used to query Data Storage 350. If the query returns preexisting service contract data, then this data is provided to Broker 330 as the selection. If no preexisting service contract data is found, then Configuration Engine 340 is optionally configured to determine a service contract on demand, using predefined preferences, capabilities and/or limitations of the service consumer and a characteristic of a service provider. These predefined preferences, capabilities or limitations are typically stored in Data Storage 350.

In a Broker Communication Step 420 the service consumer communicates with the service broker under one or more terms of the service contract. This communication may occur through standard protocols such as HTTP, FTP, SMTP, or the like. The communication protocol may be specified by a term of the service contract. In one example, Broker Communication Step 420 includes transfer of one or more service contract terms from Broker 330 to Consumer 310A, and transfer of a data relating to a network application service from Consumer 310A to Broker 330. Both of these transfers may be under terms of the service contract.

In an optional Process Data Step 430, the service broker processes data received in Broker Communication Step 420, responsive to one or more terms of the service contract. The processing of this data is initiated by, for example, the identity determined in Provide Identity Step 410 or data communicated in Broker Communication Step 420. For example, in one embodiment Broker 330 performs a format conversion as specified by a term of the service contract. In one embodiment, Broker 330 selects a service provider to provide service in response to the data received in Broker Communication Step 420, responsive to a term of the service contract and responsive to load balancing information.

In a Service Provider Communication Step 440, the service broker communicates with a service provider. This communication is initiated responsive to the data received in Broker Communication Step 420 and/or Provide Identity Step 410. This communication is performed under a term of the service contract characterized by the service contract data selected using the identity provided in Provide Identity Step 410. For example, in various embodiments, data processed by Broker 330 in Process Data Step 430 is subsequently delivered from Broker 330 to a member of Service Providers 320A-320C in Service Provider Communication Step 440. Thus, Broker 330 may act as an intermediary for communications between members of Consumers 310A-310C and Providers 320A-320C.

In some embodiments, Broker Communication Step 420 and/or Service Provider Communication Step 440 include communication of terms of the service contract, selected in Provide Identity Step 410, from Broker 330 to Consumer 310A or to Provider 320A, respectively. For example, in one instance, terms of a preexisting service contract are sent to Provider 320A in Service Provider Communication Step 440. In another instance, terms of a service contract determined on demand are sent to Consumer 310A in Broker Communication Step 420. In some embodiments, further communications between Consumer 310A and Provider 320A, performed under at least one term of the service contract, do not include Broker 330 as an intermediary.

FIG. 5 is a flow chart illustrating further methods of operating Network Application System 300. In these methods an identity of a service consumer is received by Broker 330. This identity is used to select service contract data. Further communications with the service consumer are managed according to one or more service contract terms defined by the service contract data.

In a Receive Identity Step 510 a service broker, such as Broker 330, receives an identity of a service consumer. Typically, this identity is received from the service consumer and is associated with a request for a network application service. In some instances, the request is directed toward a specific service provider, such as Provider 320A. In other instances, the request is directed toward a specific type of service, such as a CRM service which may be provided by one or more of Providers 320A-320C.

In a Select Data Step 520, Broker 330 uses the identity received in Receive Identity Step 510 to select service contract data optionally stored in Data Storage 350. The service contract data is associated with a preference, capability and/or limitation of the service consumer and a characteristic of a service provider. The service provider, having the associated characteristic, is either a service provider specified in Receive Identity Step 510 or a service provider determined by Broker 330 as capable of providing the specific type of service requested. In some instances, the service contract data is previously prepared and stored in Data Storage 350. In other instances, this service contract data is generated on demand using previously stored preferences, capabilities and/or limitations of the service consumer, and a characteristic of a service provider.

In one embodiment, a specific service provider (having the “characteristic of a service provider” associated with the service contract data) is not identified prior to Select Data Step 520. For example, the characteristic may be “an ability to provide a CRM service” and Broker 330 may select any set of service contract data, associated with any service provider, that satisfies this characteristic and the preferences, capabilities or limitations of the service consumer.

In a Consumer Communication Step 530, communication takes place with the service consumer under at least one service contract term characterized by the service contract data selected in Select Data Step 520. This service contract term may include, for example, a preferred data format, a data transport protocol, a security scheme, a quality of service or performance requirement, or the like. Consumer Communication Step 530 optionally includes communication of information required for performing the requested service. For example, the communication may include financial data to be processed by an application service provider configured to perform accounting functions.

In an optional Process Data Step 540, data received in Consumer Communication Step 530 is processed by the service broker, responsive to one or more terms of the service contract characterized by the selected service contract data. For example, in one embodiment, Broker 330 receives a user identification and password sufficient to establish a secure communication session, and in response generates an authentication certificate in a form required by a service provider.

In a Provider Communication Step 550, communications occur with a service provider, such as Provider 320A, under at least one service contract term characterized by the service contract data selected in Select Data Step 520. In some embodiments, these communications occur between Broker 330 and Provider 320A. In other embodiments, these communications occur between Consumer 310A and Provider 320A, without necessarily passing through, or requiring further instruction from, Broker 330.

In various embodiments of the invention, a copy of service contract data selected responsive to a service consumer identity, such as in Select Data Step 520, is retrieved from Data Storage 350 and stored in Broker 330. This stored copy is optionally used for processing of data received from Consumer 310A or Producer 320A, for example, during Process Data Step 430 or Process Data Step 540. When this data is stored locally to Broker 330, it may be more efficiently accessed during use than when stored in Data Storage 350. In some cases the locally stored data is pre-compiled and stored in a pre-compiled form for run-time use. For example, in one embodiment, data is stored in Data Storage 350 in an Extended Markup Language (XML) format. Following selection, it is pre-compiled into an executable code callable through function calls or pointers during the processing of data.

In various embodiments, Process Data Step 430 or Process Data Step 540 are used many times as a service is provided by a service provider to a service consumer. For example, in some cases, Broker 330 receives communication from Consumer 310A, processes the received data responsive to a service contract term, and then sends the result of the processing to Provider 320A. In response, the Provider 320A sends a further communication back. This further communication is again processed responsive to a service contract term, and the result of processing the further communication is sent to Consumer 310A. This sequence of steps is optionally repeated as Provider 320A provides an application service to Consumer 310A.

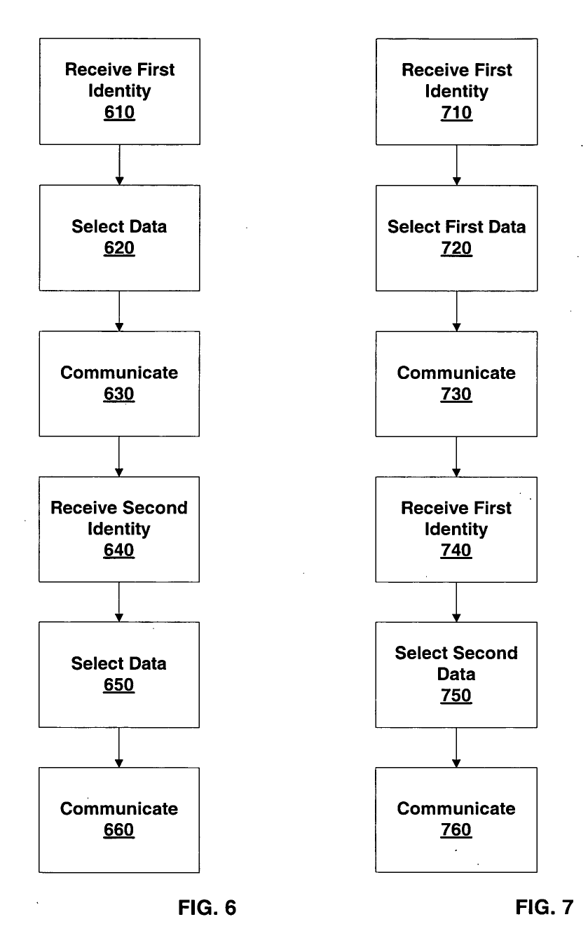

FIG. 6 illustrates various embodiments of the invention in which a service provider provides application services to more than one service consumer. The service may be provided under different service contract terms, responsive to the preferences, capabilities and/or limitations of each service consumer.

In a Receive First Identity Step 610, Broker 330 receives the identity of a first service consumer, such as Consumer 310A. This step is similar to Receive Identity Step 510. In a Select Data Step 620, service contract data is selected based on the consumer identity received in Receive First Identity Step 610 and a characteristic of a service provider. This characteristic of a service provider may be a preference, capability, limitation, or the like. For example, in one instance the characteristic includes a capability of providing the requested service and a preference for a communication protocol that is also preferred by the service consumer. In a Communicate Step 630, the application service is provided under at least one service contract term specified by the service contract data selected in Select Data Step 620. Communicate Step 630 typically includes communication between the service consumer and service provider, optionally through Broker 330.

In a Receive Second Identity Step 640, Broker 330 receives the identity of a second service consumer, such as Consumer 310B. This step is similar to Receive First identity Step 610 except that the second identity is different from the first identity. In a Select Data Step 650, service contract data is selected responsive to the identity of the second service consumer. The service contract data selected in Select Data Step 650 may be different from the service contract data selected in Select Data Step 620, even when the data is responsive to the same characteristic of a service provider. In a Communicate Step 660 an application service is provided to the second service consumer, based on the service contract data selected in Select Data Step 660.

FIG. 7 illustrates embodiments of the invention in which a service consumer obtains application services from two different service providers under different service contract terms. In a Receive First Identity Step 710, Broker 330 receives an identity of the service consumer. This step is similar to Receive First Identity Step 610. In Receive First Identity Step 710 Broker 330 also receives a request for a first application service, such as a finance service. This request may be directed toward a specific application service provider, such as Provider 320A, or Broker 330 may determine an appropriate service provider to provide the requested service.

In a Select First Data Step 720, the identity of the service consumer and a characteristic of a first service provider (either the specific service provider to which the request was directed or the service provider determined by Broker 330), are used to select service contract data characterizing at least one term of a first service contract.

In a Communicate Step 730, communication between the first service provider and the service consumer is used to deliver the requested application service to the service consumer. This communication is under terms of the first service contract.

In a Receive First Identity Step 740 the identity of the service consumer is again received by Broker 330. Broker 330 also receives a request for a second application service, such as a CRM service. In a Select Second Data Step 750, the identity of the service consumer and a characteristic of a second service provider (capable of providing the second application service), are used to select service contract data characterizing at least one term of a second service contract. The second service contract data selected in Select Second Data Step 750 is typically different than the first service contract data selected in Select First Data Step 720, even though they are both derived from the same preferences, capabilities or limitations of the service consumer.

In a Communicate Step 760, communication between the second service provider and the service consumer is used to deliver the requested second application service to the service consumer. This communication is under terms of the second service contract.

In some embodiments, Network Application System 300 is configured as a service access system through which one or more of service Consumers 310A-310C may search for services offered by Providers 320A-320C. For example, in some embodiments, Online Service Marketplace 360 is configured to provide a service marketplace accessible to one or more of Consumers 310A-310C. In these embodiments, a member of Consumers 310A-310C may access Online Service Marketplace 360n order to shop for a service satisfying specific preferences, requirements, or limitations. This service shopping system includes mechanisms that allow service consumer data to be used for identifying a service provided by one of Provider 320A-320C. For example, some embodiments include a service search system configured to use a consumer preference, a consumer limitation and/or a consumer capability as a search term. Such search term(s) may be used to query a database including a plurality of service provider data associated with a plurality of services provided by one or more members of Providers 320A-320C. In some embodiments, search terms including a consumer preference, a consumer limitation and/or a consumer capability are entered in a browser based search interface for communication to Network Application System 300. The database searched is optionally stored in Data Storage 350, in Broker 330, Online Service Marketplace 360, or the like.

The searched service provider data includes a characteristic of a service provider (e.g., a preference of the service provider, a requirement of a service provided by that service provider, or the like). Once identified through a search process, the service provider data is optionally used to generate service contract data responsive to the characteristic of the service provider and the consumer preference, consumer limitation or consumer capability.

When configured as a service access system, Network Application System 300 typically includes Online Service Marketplace 360 configured for a service consumer, such as Consumers 310A-310C, to select a service from among a plurality of services. For example, in some embodiments Network Application System 300 includes an interface accessible through Network 140 and configured to receive selection criteria from a member of Consumer 310A-310C. The selection criteria may include a consumer preference, and/or a consumer limitation or a consumer capability.

Online Service Marketplace 360 may be associated with a service access system that includes one service provider such as Provider 320A, or a plurality of service providers such as Providers 320A-320C. For example, in some embodiments, the service access system is configured for accessing one or more services provided by a single service provider, such as Provider 320A. In these embodiments, Online Service Marketplace 360 is typically managed by the single service provider. In alternative embodiments, Online Service Marketplace 360 is configured for accessing services provided by a plurality of services providers.

Configuration Engine 340 is optionally configured to determine service contract data responsive to the selection criteria. For example, in some embodiments Configuration Engine 340 is configured to generate service contract data using the selection criteria and provider data identified using the selection criteria. The generated service contract data being configured to characterize one or more terms of a service contract facilitated by Broker 330 and provided via Network 140. Depending on the particular selection criteria, further service consumer data may be required to generate contract data sufficient for characterizing a complete service contract.

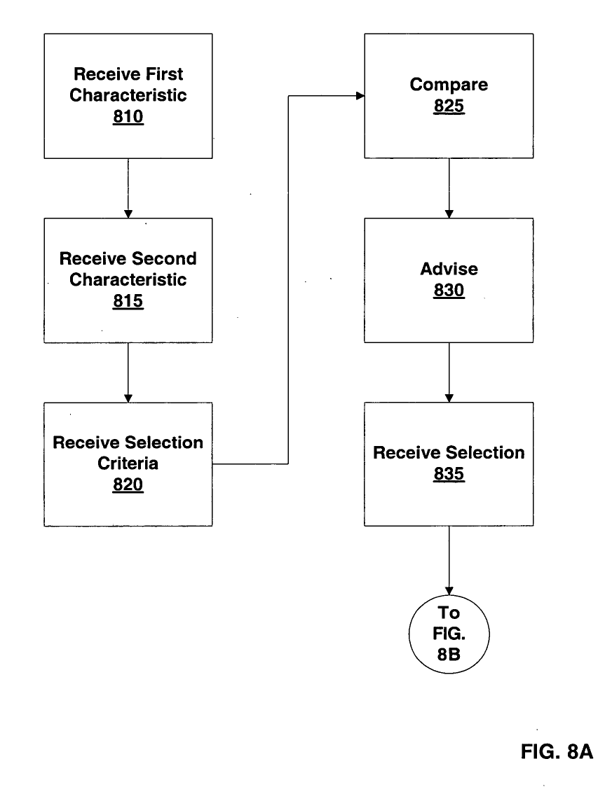

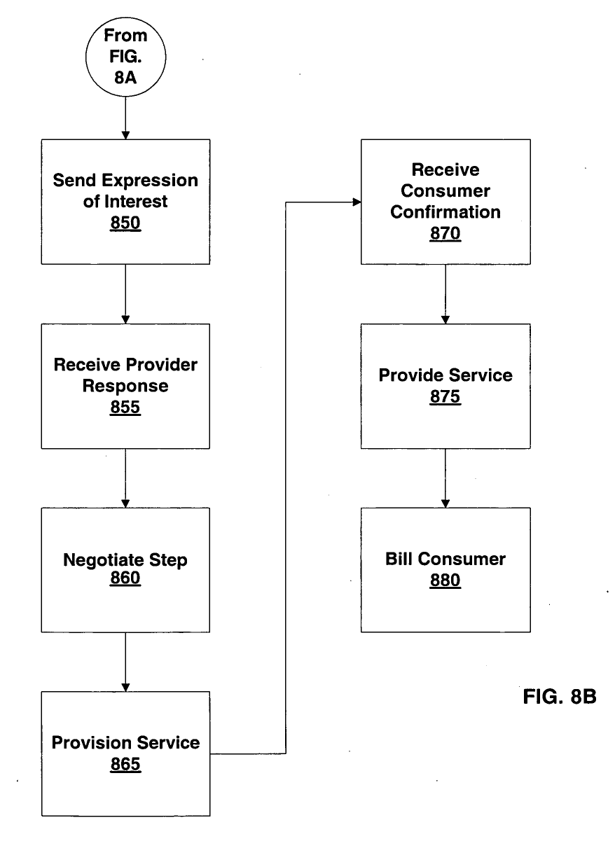

FIG. 8A illustrates a method of identifying a service, according to various embodiments of the invention. In this process, Network Application System 300 operates as a service access system. Online Service Marketplace 360 receives and stores characteristics of one or more of Providers 320A-320C, and uses selection criteria received from one or more of Consumers 310A-310C to search for and select a service based on the stored characteristics.

In a Receive First Characteristic Step 810, Online Service Marketplace 360 receives a first characteristic of a service provider (e.g., one of Providers 320A-320C). This characteristic may be a preference, limitation, capability, requirement, or the like, of the service provider and may be applicable to one or more services provided by that service provider. The received characteristic is stored, for example in Data Storage 350, in memory within Online Service Marketplace 360, or in another location accessible to Network Application System 300.

In a Receive Second Characteristic Step 815, a second characteristic of a service provider is received by Online Service Marketplace 360. The second characteristic is associated with the same service provider as the first characteristic or associated with a different service provider. The second characteristic is further associated with one or more services provided by the service provider with which it is associated. The second characteristic is stored in a location accessible to Network Application System 300, in a manner similar to the storage in Receive First Characteristic Step 810.

In a Receive Selection Criteria Step 820, Online Service Marketplace 360 receives selection criteria from a service consumer (e.g., one of Consumers 310A-310C). The selection criteria include consumer data such as a consumer preference, a consumer limitation, and/or a consumer capability. The selection criteria are optionally configured for determining contract data using Broker 330 and/or Configuration Engine 340. For example, the received selection criteria may be a consumer limitation, which alone or in combination with further consumer data may be used to develop a service contract responsive to service provider data.

In a Compare Step 825 the received selection criteria is used to search stored characteristics of service providers, such as those characteristics received in Receive First Characteristic Step 810 and Receive Second Characteristic Step 815. This search is optionally performed by querying a database, the query being responsive to the received selection criteria. Compare Step 825 may result in identification of one or more stored search characteristics associated with services that match a preference, capability, or limitation specified within the selection criteria. For example, if the received selection criteria include a consumer limitation, the result of Compare Step 825 may include a set of services and associated service providers capable of forming a service contract that satisfies that limitation.

In an Advise Step 830, the service consumer from which the selection criteria were received in Receive Selection Criteria Step 820 is notified of the result of Compare Step 825. In some embodiments, this notification occurs through a browser and a network such as Network 140. For example, the user may be presented with a list of services that match the selection criteria, further attributes of these services, and/or an option to pursue a service contract for these services. The further attributes may include the identity of a service provider providing the service, characteristics of the service provider, price, or cross references to related services. In some embodiments, related services include those typically found upstream or downstream in a business process. For example, in a typical business process an order entry service may be followed by a shipping service which in turn may be followed by a billing service. Online Service Marketplace 360 may be configured to use these relationships to promote the related service to a service consumer. For example, a service consumer searching for a shipping service may be offered information about a billing service in addition to any selection criteria received in Receive Selection Criteria Step 820.

In an optional Receive Selection Step 835, a response to the notice provided in Advise Step 830 is received from the service consumer. This response may include selection of one service of the set of services, and/or a request to form a service contract with a service provider associated with the selected service.

In some embodiments Network Application System 300 is configured for use in developing new services that may be offered by Service Providers 320A-320C. The development of new services may occur as an interactive process between a service consumer and a service provider, and/or may occur using historical data collected over a period of time.

In those embodiments including an interactive process between a service consumer and a service provider, the service consumer may express an initial level of interest based on first consumer data such as the search criteria received in Receive Selection Criteria Step 820. For example, the first consumer data may be sufficient to determine a first contract term and the service consumer may request negotiation of further contract terms. Negotiations are optionally performed interactively between one of Consumers 310A-310C and Providers 320A-320C and may be facilitated by Online Service Marketplace 360. In some embodiments, willingness to negotiate specific contract terms is a characteristic (e.g., preference, limitation, or capability) of a service provider. The negotiation process optionally includes the use of Configuration Engine 340 to automatically generate contract data characterizing contract terms in response to service consumer data and service provider data provided by the negotiating parties. The negotiation process optionally includes exchange of further service consumer data and/or service provider data.

In those embodiments wherein historical data is used to develop new services a data analyzer may be configured to statistically analyze historical consumer data received from one or more of Consumers 310A-310C. The data analyzer may be included in, for example, Broker 330, Configuration Engine 340, or Online Service Marketplace 360. These statistical analyses are typically configured to determine consumer preferences, consumer limitations and/or consumer capabilities that are commonly specified by Consumers 310A-310C. A result of the statistical analysis may be used to determine a characteristic of a service provider. For example if the consumer data includes a preponderance of a particular consumer preference, one of Providers 320A-320C may use this preponderance to develop a new service or modify an existing service configured to satisfy this popular consumer preference. In this example, the new characteristic of the service, determined using the result of the statistical analysis, includes a provider capability configured to satisfy the popular consumer preference. Likewise, in various embodiments the determined characteristic may be a provider preference, a provider limitation, or the like.

FIG. 8B illustrates methods of providing an identified service to a service consumer, according to various embodiments of the invention. The service may be identified, using embodiments of the invention discussed with respect to FIG. 8A, or using other methods.

In a Send Expression of Interest Step 850 a service consumer's expression of interest in a service is sent from Online Service Marketplace 360 to a provider of the service. The consumer's expression of interest was optionally previously received by Online Service Marketplace 360 in Receive Selection Step 835 of FIG. 8A. For example, if Consumer 310A is presented with services offered by a plurality of service providers in Advise Step 830 and a selection of one of these services is received by Online Service Marketplace 360 in Receive Selection Step 835, then a provider of the selected service (e.g., a member of Providers 320A-320C) is notified of Consumer 310A's interest in Send Expression of Interest Step 850.

In some embodiments, Send Expression of Interest Step 850 completes the involvement of Online Service Marketplace 360 in the provision of the service. In these embodiments, subsequent steps may be performed directly between a member of Consumers 310A-310C and a member of Providers 320A-320C, may be assisted by Configuration Engine 340 (FIG. 3) or Broker 330, and/or may be assisted by a service broker independent of Network Application System 300. In alternative embodiments, as described further herein, subsequent steps continue to involve Online Service Marketplace 360.

In some embodiments, Send Expression of Interest Step 850 is performed responsive to a check-out procedure performed by a member of Consumers 310A-310C at Online Service Marketplace 360. For example, in some embodiments, Receive Selection Step 835 may be repeated several times as the member of Consumers 310A-310C uses Online Service Marketplace 360 to shop for several different services. Each received selection is assigned to a virtual shopping cart associated with the member of Consumers 310A-310C. When the Member of Consumers 310A-310C has completed their selections, they may notify Online Service Marketplace 360 that they are finished by performing a checkout process. In response to the checkout process, Send Expression of Interest Step 850 includes sending an expression of interest to the provider of each of the one or more services selected, as indicated by the selections assigned to the virtual shopping cart.

The expression of interest sent in Send Expression of Interest Step 850 typically includes identification information regarding the member of Consumers 310A-310C who expressed the interest, preferences, capabilities and/or limitations of the consumer, the service(s) to which the service consumer has expressed interest and/or, optionally, further requests of the consumer. For example, in one embodiment, the expression of interest includes preferences, capabilities and/or limitations of the consumer that were matched with characteristics of the service provider in Compare Step 825 (FIG. 8A), and consumer requests relating to price and/or other terms of a possible service contract between the service consumer and the service provider.

In a Receive Provider Response Step 855 a response to the expression of interest sent in Send Expression of Interest Step 850 is received by Online Service Marketplace 360, Broker 330, the service consumer that expressed the interest, and/or a third party. The response may include acceptance or rejection of contract terms requested by the service consumer, as well as suggested proposals for alternative terms. For example, the service provider may reject a price suggested by the service consumer and suggest an alternative price. If the response is received by Online Service Marketplace 360, Broker 330 or a third party then it is forwarded on to the service consumer. For example, if the service consumer and the service provided that negotiation of further service contract terms would take place through a third party suggested by the service consumer, then this third party will receive the response from the service provider and forward it to the service consumer.

In an optional Negotiate Step 860 further communication takes place between the service consumer and the service provider until a complete set of terms required to form a service contract are agreed to or the attempt at forming a service contract is abandoned. This communication optionally passes through Online Service Marketplace 360, Broker 330 or a third party.

When a complete set of terms required to form a service contract are agreed to, the service is provisioned in a Provision Service Step 865. In some embodiments, provisioning of the service includes generating the service contract data required by a service broker, such as Broker 330, in order to broker a service provided by a member of Providers 320A-320C to a member of Consumers 310A-310C. In other embodiments, provisioning of the service includes generating service contract data configured for a member of Providers 320A-320C to provide a service directly to a member of Consumers 310A-310C without a service broker acting as an intermediary. Regardless of whether the service contract data is configured for use with a service broker or not, provisioning of the service includes providing material required for providing the service, typically from a specific member of Consumers 310A-310C to a specific member of Providers 320A-320C. The generated service contract data is based on the terms agreed to by the service consumer and the service provider, and optionally further based on default terms. Generation of service contract data is typically performed using Configuration Engine 340 and/or Broker 330 as described further herein.

Send Expression of Interest Step 850, Receive Provider Response Step 833, Negotiate Step 860 and/or Provision Service Step 865 may be performed several times during the process of developing an provisioning a final contract. For example, in some embodiments, an initial expression of interest received during a first occurrence of Send Expression of Interest Step 850 is sufficient to provision a contract for a service consumer to access further information about a product (the access being provided under the contract). After being granted access to the further information, the service consumer may send a further expression of interest (repeating Send Expression of Interest Step 850) in seeing a product demo. If Negotiate Step 860 is successful, for example if the consumer is willing to provide some more basic information, then a second contract may be provisioned. This provisioning is a repeat of Provision Service Step 865 and results in a contract that allows the service consumer to access the demo. Finally, this process may be repeated to provide full access for the service consumer to use the service. Thus, the steps illustrated in FIG. 8B may be used provision a hierarchical set of service contracts, each providing for greater or different access to a service. In one embodiment, this hierarchical set is configured to allow a service consumer to access: a) initial information about a service, b) a detailed description of the service, c) a demo, d) a consumer account; full use of the service, and/or the like.

Provisioning of a service contract does not necessarily included performance of the service contract. For example, Provision Service Step 865 typically includes storage of the generated service contract data for later use. This storage is in a location accessible at a time the service is provided, such as Data Storage 350, at a member of Providers 320A-320A and/or at a member of Consumers 310A-310C. In various embodiments, the contract is embodied in an XML format, as pre-compiled executable code, as a script, or the like.

In some embodiments the provisioned service contact is considered a binding contract which both a member of Consumers 310A-310B and a member of Providers 320A-320C expect to fulfill. In some embodiments, the provisioned service contract is considered a contract offer from a member of Providers 320A-320C. In these embodiments an acceptance by a member of Consumers 310A-310C will form a binding contract to provide and accept the service.

In an optional Receive Consumer Confirmation Step 870 a member of Providers 320A-320C receives a confirmation from a member of Consumers 310A-310C that the member of Consumers 310A-310C would like to receive a service as specified in a specific service contract. In some embodiments, this confirmation constitutes acceptance of a contract offer from the member of Providers 320A-320C as specified in a provisioned service contract. Typically, the confirmation includes an identification of the specific provisioned service contract.

In a Provide Service Step 875 the service is provided by the member of Providers 320A-320C to the member of Consumers 310A-310C under the terms of the service contract provisioned in Provision Service Step 865. In some embodiments, this service is provide through Broker 330. In these embodiments, Broker 330 may actively participate in the transaction. For example, in some embodiments, Broker 330 may identify alternative members of Providers 320A-320C willing to provide the service under the terms of the service contract. The identified alternative service provider may then serve as a backup or alternative source of the service if the original member of Providers 320A-320C becomes unavailable. In some embodiments, Broker 330 is configured to use the alternative service provider responsive to real-time availability of the original service provider in order to optimize load balancing between Providers 320A-320C. In some embodiments, a service broker, such as Broker 330 is configured to enforce terms of a service contract that characterize a security protocol. In some embodiments, a service broker, such as Broker 330 is configured to enforce terms of a service contract that characterize a data logging procedure.

In various embodiments, an active broker, such as Broker 330, may be configured to debit an account of a service consumer, credit an account of a service provider, perform credit management, and/or terminate provision of a service responsive to financial considerations. For example, in some embodiments, Broker 330 is configured to determine the value deposited in an account of a member of Service Consumers 310A-310C, debit this account as the member of Consumers 310A-310C consumes a service, and halt further services when this account falls below a minimum value.

In alternative embodiments, Broker 330 plays a more passive role in providing the provisioned service. For example, in some embodiments Broker 330 functions as a passive agent that does not participate actively in provision of the service but monitors contract compliance, tracks user data, collects information used for billing, or the like. In these embodiments, the service is provided through the agent or through a communication channel monitored by the agent. The agent performs compliance monitoring or data collection responsive to terms of the service contract.

In alternative embodiments, the service is provided by a member of Providers 320A-320C to a member of Consumers 310A-310C without use of an agent or a service broker such as Broker 330. In these embodiments, the member of Providers 320A-320C and the member of Consumer 310A-310C are responsible for performing under the terms of the provisioned service contract.

Once a service contract is provisioned in Provision Service Step 865, the service may be facilitated by a service broker or passive agent other than Broker 330. For example, in some embodiments, the service contract data generated in Provision Service Step 865 is used by a service broker or passive agent not associated with Online Service Marketplace 360 or included in Network Application System 300. In these embodiments the service contract data may be stored with a member of Consumers 310A-310C, with a member of Providers 320A-320C, or with a third party.

In an optional Bill Consumer Step 880 data collected by a service broker or a passive agent is used to bill a member of Consumers 310A-310C for the service provided by a member of Providers 320A-320C. This billing optionally includes debiting of an account or credit card according to terms of the service contract. Billing is optionally responsive to data collected by the service broker or passive agent during Provide Service Step 875. For example, billing may be responsive to an amount of time the service was used by the service consumer, data accessed by the service consumer, or specific contract terms evoked by the service consumer.

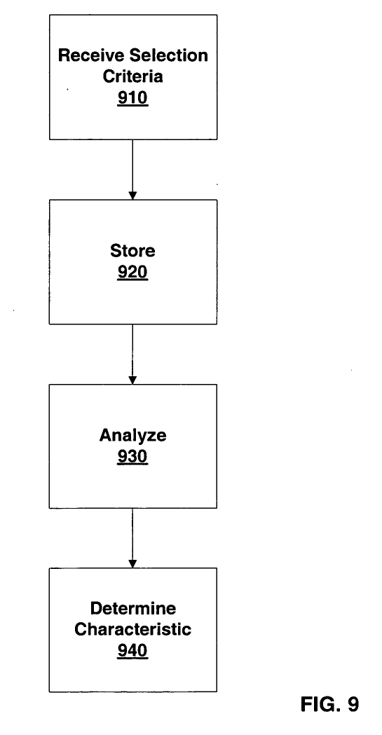

FIG. 9 illustrates a method of using historical data for developing new services or modifying existing services, according to various embodiments of the invention. In this method historical consumer data including consumer preferences, consumer limitations, and/or consumer capabilities are used to develop new services or to modify existing services. Typically, the new service or the modification is configured to better serve the needs of services consumers as suggested by the historical consumer data.

In a Receive Selection Criteria Step 910, selection criteria is received from one or more service consumers, such as Consumers 310A-310C. The selection criteria may include preferences, capabilities and/or limitations of the services consumers. In some embodiments, the consumer data is received from different service consumers over a period of days or months.

In a Store Step 920, the received selection criteria are stored as historical consumer data. The historical consumer data is typically stored in a location accessible to Configuration Engine 140, Broker 330, Online Service Marketplace 360, or a member of Providers 320A-320C. In some embodiments, the historical consumer data is stored in a relational database.

In an Analyze Step 930, the stored historical consumer data is statistically analyzed to identify trends, opportunities for providing improved services, typical consumer preferences, requirements and limitations, or the like. In some embodiments, the statistical analysis is performed using data mining technology. In some embodiments, the statistical relationship includes positive or negative correlations (or lack thereof) between various consumer preferences, consumer limitations, and consumer requirements. For example, the statistical analysis may find that consumers preferring a first security protocol are often also capable of supporting a second security profile, or that two different communication protocols satisfy the preferences of 98% of service consumers, etcetera.

In a Determine Characteristic Step 940, a characteristic of a service provider, such as Providers 320A-320C, is determined based on the statistical analysis of Analyze Step 930. Typically, determination of the characteristic includes establishing a new service or modification of an existing service provided by the service provider. The characteristic may include a provider preference, a provider capacity, a provider limitation, etcetera. For example, in one embodiment, a capacity to receive data in a standard format may be added to an existing service, in response to identification, in Analyze Step 930, that this standard format is a preference for a substantial number of service consumers.

Several embodiments are specifically illustrated and/or described herein. However, it will be appreciated that modifications and variations are covered by the above teachings and within the scope of the appended claims without departing from the spirit and intended scope thereof. For example, a service consumer not yet associated with an identity may provide preferences, capabilities or limitations to a service broker and the service broker may assign a new identity, store the provided data, and determine a service contract on demand. Further, contract terms may be associated with logging rules, custom alerts, access control, load balancing, or the like.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A service access system comprising
an online service marketplace configured for selecting a first service from among a plurality of services, the selection of the first service being responsive to selection criteria received from a service consumer, the selection criteria including a consumer preference, a consumer limitation or a consumer capability; and
a mechanism configured to determine first service contract data responsive to the selection criteria and the service provider data, the first service contract data being configured for characterizing a first service contract, the service contract configured for a service provider to provide the first service to a service consumer using a computer network.

2. The service access system of claim 1, further including a service broker configured for carrying out of the first service according to the first service contract data.

3. The service access system of claim 1, further including a service broker configured for carrying out of the first service according to terms of the first service contract that characterize a security protocol.

4. The service access system of claim 1, further including a service broker configured for carrying out of the first service according to terms of the first service contract that characterize a data logging procedure.

5. The service access system of claim 1, further including a service broker configured for select the service provider from among a plurality of service providers responsive to load balancing among the plurality of service providers.

6. The service access system of claim 1, further including the service provider configured to provide the first service and characterized by service provider data including a provider preference, a provider capability, a provider requirement or a provider limitation.

7. The service access system of claim 1, wherein the online service marketplace is further configured for selecting a second service from among the plurality of services, the selection of the second service being response to the selection criteria.

8. The service access system of claim 1, wherein the online service marketplace is further configured to offer a second service to the service consumer.

9. The service access system of claim 8, wherein the second service is selected responsive to the selection criteria.

10. The service access system of claim 8, wherein the second service is selected responsive to a relationship with the first service.

11. The service access system of claim 10, wherein the relationship is that of an up-stream service and a down-stream service.

12. The service access system of claim 1, wherein the plurality of services are provided by a plurality of service providers.

13. The service access system of claim 1, wherein the first service contract is responsive to:
a) a consumer preference, or
b) a consumer limitation and a consumer capability.

14. The service access system of claim 1, wherein the online service marketplace is configured to present a plurality of selected services to the service consumer, the plurality of selected services being selected responsive to the selection criteria.

15. The services access system of claim 1, wherein the online service marketplace is configured for the service consumer and the service provider to determine a term of the service contract through negotiation, the negotiation including exchange of preferences, capabilities or limitations of the service consumer or service provider.

16. The services access system of claim 1, wherein the first service contract is configured for the service provider to provide the first service to the service consumer using a service broker external to the services access system.

17. The services access system of claim 16, where in the first service contract is configured for the service provider to provide the first service to the service consumer using a service broker external to the services access system, the service broker being configured to identify one or more alternate service provider that can provide the first service under the terms of the first service contract.

18. The services access system of claim 16, where in the first service contract is configured for the service provider to provide the first service to the service consumer using a service broker external to the services access system, the service broker being configured to provide security according to terms of the first service contract.

19. The services access system of claim 1, wherein the first service contract is configured for the service provider to provide the first service to the service consumer using a passive agent external to the services access system, the passive agent being configured to collect information used in billing the service consumer for the first service.

20. A service search system comprising:
an online service marketplace accessible to a service consumer, the service consumer having an identity and being characterized by
a) a consumer preference, or
b) a consumer limitation and a consumer capability, the online service marketplace including
an input/output configured to exchange service consumer data with the service consumer,
a mechanism configured to use the service consumer data to identify first service provider data from among a plurality of service provider data, the first service provider data being associated with a service provided by a service provider and being configured to for generating service contract data responsive to the consumer preference, consumer limitation or consumer capability, of the service consumer, and
a memory configured to store the plurality of service provider data.

21. The service search system of claim 20, wherein the mechanism includes software.

22. The service search system of claim 20, wherein the mechanism includes a database configured to store the service provider data in the memory.

23. The service search system of claim 20, where in the online service marketplace is associated with a broker configured for executing a contract between the service provider characterized by the service provider data and the service consumer, the contract being characterized by the service contract data.

24. The service search system of claim 20, wherein the online service marketplace is managed by the service provider.

25. The service search system of claim 20, further including a configuration engine configured for generating the service contract data using the first service provider data responsive to a characteristic of the service provider and the consumer preference, consumer limitation or consumer capability, of the service consumer

26. The service search system of claim 20, wherein the input/output is configured to display the first service provider data to the service consumer.

27. The service search system of claim 26, wherein the input/output is further configured to display second service provider data to the service consumer.

28. The service search system of claim 20, wherein the mechanism is further configured for negotiating one or more terms of the first service contract data responsive to a preference, limitation or capability of the service consumer or of the service provider.

29. A service development system comprising:
a service marketplace configured for receiving selection criteria from a plurality of service consumers, each of the selection criteria including a consumer preference, a consumer limitation or a consumer capability, the selection criteria being configured for selecting a service from among a plurality of services;
memory configured to store the received selection criteria;
a data analyzer configured to process the stored selection criteria and to statistically analyze the consumer preferences, consumer limitations or consumer capabilities included in the stored selection criteria; and
a service provider configured to provide a first service developed responsive to the statistical analysis.

30. The service development system of claim 29, wherein the first service is configured to be provided using a service contract facilitated by a service broker.

31. The service development system of claim 29, wherein each of the selection criteria include: a) a consumer preference, or b) a consumer limitation and a consumer capability

32. A contract negotiation system comprising:
a service marketplace configured for receiving selection criteria from a service consumer, the selection criteria including a consumer preference, a consumer limitation or a consumer capability, the selection criteria being configured for showing an initial interest in a service from among a plurality of services;
memory configured to store the received selection criteria;
a configuration engine configured for determining a first contract term of a contract using the selection criteria and a characteristic of a service provider configured to provide the service to the service consumer; and
an input/output interface configured for negotiating a second term of the contract using a preference, limitation or capability of the service consumer or the service provider.

33. The contract negotiating system of claim 32, wherein the service marketplace is further configured to use the selection criteria for searching the plurality of services.

34. The contract negotiation system of claim 32, further including a service broker configured for facilitating the provision of the plurality of services.

35. The contract negotiation system of claim 32, wherein the memory is further configured to store service provider data, the service provider data configured to indicate a willingness of the service provider to negotiate one or more terms of a contract facilitated by a service broker.

36. The contract negotiating system of claim 32, wherein the characteristic of a service provider is a characteristic of the service provided by the service provider.

37. A method of providing a service, the method comprising:
receiving at an online service marketplace a first characteristic of a first service;
receiving at the online service marketplace a second characteristic of at least a second service;
receiving at the online service marketplace selection criteria from a service consumer, the selection criteria including
a) a consumer preference, and/or
b) a consumer limitation and a consumer capability, the selection criteria configured for determining contract data, the
determination being responsive to the first characteristic or the second characteristic;
comparing the selection criteria with the first characteristic and with at least the second characteristic, the results of the comparison including identification of one or more service that meets the selection criteria; and
advising the service consumer of results of the comparison.

38. The method of claim 37 further including receiving an expression of interest in at least one of the identified services from the service consumer.

39. The method of claim 38, further including determining a first contract term based on the selection criteria and the received expression of interest.

40. The method of claim 39, further including negotiating a second contract term.

41. The method of claim 40, wherein the second contract term is negotiated responsive to the consumer preference, consumer capacity or consumer limitation of the service consumer.

42. The method of claim 39, further including sending the received expression of interest to a service provider, the service provider being a provider of the at least one of the identified services.

43. A method of providing a service, the method comprising:
receiving at an online service marketplace a first characteristic of a first service;
receiving at the online service marketplace a second characteristic of at least a second service;
receiving at the online service marketplace selection criteria from a service consumer, the selection criteria configured for determining contract data, the determination being responsive to the first characteristic or the second characteristic;
comparing the selection criteria with the first characteristic and with at least the second characteristic, the results of the comparison including identification of one or more service that meets the selection criteria;
advising the service consumer of results of the comparison;
receiving an expression of interest in at least one of the identified services from the service consumer; and
provisioning the at least one of the identified services, the provisioning including generation of service contract data, the service contract configured for the service provider to provide the service to the service consumer under one or more terms of a service contract.

44. The method of claim 43, further including provisioning the at least one of the identified services, the provisioning including generation of service contract data responsive to the selection criteria.

45. The method of claim 43, further including providing the at least one of the identified services through a service broker.

46. The method of claim 43, further including providing the at least one of the identified services through a service broker associated with the online service marketplace.

47. The method of claim 43, further including providing the at least one of the identified services using a passive agent configured to collect information relating to billing the service consumer for the at least one of the identified services.

48. The method of claim 43, further including negotiating further terms of the service contract.

49. The method of claim 43, further including sending the received expression of interest to a service provider, the service provider being a provider of the at least one of the identified services;

50. The method of claim 43, wherein the generated service contract data characterizes at least one term of the service contract responsive to the selection criteria.

51. The method of claim 43, wherein the generated service contract data characterizes at least one term of the service contract responsive to the selection criteria and at least one default term.

52. A method of developing a service, the method comprising:
receiving a plurality of selection criteria from a plurality of service consumers, each of the selection criteria including
a) a consumer preference, and/or
b) a consumer limitation and a consumer capability;
storing the received selection criteria;
statistically analyzing the consumer preferences, consumer limitations or consumer capabilities included in the stored selection material; and
determining a new characteristic of the service responsive to the statistical analysis, the characteristic being configured for determining contract data in conjunction with the selection criteria.

53. The method of claim 52, wherein the received plurality of selection criteria include a consumer preference, a consumer limitation, and a consumer capability.

54. The method of claim 52, wherein the statistical analysis is configured to identify a correlation between the consumer preferences, consumer limitations and consumer capabilities.

55. The method of claim 52, wherein the statistical analysis is configured to identify common consumer preferences, consumer limitations or consumer capabilities.

56. A computer readable medium including computing instructions, the computing instructions comprising:
a code segment configured for receiving a plurality of selection criteria from a plurality of service consumers, each of the selection criteria including
a) a consumer preference, and/or
b) a consumer limitation and a consumer capability;
a code segment configured for storing the received selection criteria;
a code segment configured for statistically analyzing the consumer preferences, consumer limitations or consumer capabilities included in the stored selection material; and
a code segment configured for determining a characteristic of the service responsive to the statistical analysis, the characteristic, in conjunction with the selection criteria, being configured for determining contract data.

57. A computer readable medium including computing instructions, the computing instructions comprising:
a code segment configured for receiving at an online service marketplace a first characteristic of a first service;
a code segment configured for receiving at the online service marketplace a second characteristic of at least a second service;
a code segment configured for receiving at the online service marketplace selection criteria from a service consumer, the selection criteria including
a) a consumer preference, and/or
b) a consumer limitation and a consumer capability, the selection criteria configured for determining contract data, the
determination being responsive to the first characteristic or the second characteristic;
a code segment configured for comparing the selection criteria with the first characteristic and with at least the second characteristic, the results of the comparison including identification of one or more service that meets the selection criteria; and
a code segment configured for advising the service consumer of results of the comparison.

58. A computer readable medium including computing instructions, the computing instructions comprising:
a code segments configured for receiving a plurality of selection criteria from a plurality of service consumers, each of the selection criteria including
a) a consumer preference, and/or
b) a consumer limitation and a consumer capability;
a code segments configured for storing the received selection criteria;
a code segments configured for statistically analyzing the consumer preferences, consumer limitations or consumer capabilities included in the stored selection material; and
a code segments configured for determining a new characteristic of the service responsive to the statistical analysis, the characteristic being configured for determining contract data in conjunction with the selection criteria.
